(19) United States
(12) Patent Application Publication
(10) Pub. No.: US 2013/0290010 A1
(43) Pub. Date: Oct. 31, 2013

(54) MEDICATION SERVICE TERMINAL AND METHOD OF MONITORING THE SAME

(71) Applicants: Jae Hun Choi, Daejeon (KR); Myung-eun Lim, Daejeon (KR); Soo Jun Park, Seoul (KR)

(72) Inventors: Jae Hun Choi, Daejeon (KR); Myung-eun Lim, Daejeon (KR); Soo Jun Park, Seoul (KR)

(73) Assignee: Electronics and Telecommunications Research Institute, Daejeon (KR)

(21) Appl. No.: 13/620,646

(22) Filed: Sep. 14, 2012

(30) Foreign Application Priority Data
Apr. 27, 2012 (KR) 10-2012-0044222

(51) Int. Cl. G06Q 50/22

(52) U.S. Cl. 705/2

(57) ABSTRACT

The inventive concept herein relates to medication service terminals and methods of monitoring the same, and more particularly, to a method of monitoring medication states of a plurality of users. The medication service terminal in accordance with the inventive concept may include a situation judgment module judging a medication situation with reference to a medication providing schedule and a terminal state that are provided from a server; and an output module determining a medication service corresponding to the medication situation and providing the determined medication service in the form that a user can sense. A communication with the server is performed only when the situation judgment module receives a medicine providing schedule from the server. According to some embodiments of the inventive concept, a medication monitoring system can be effectively provided to a massive user.

### CROSS-REFERENCE TO RELATED APPLICATIONS

This U.S. non-provisional patent application claims priority under 35 U.S.C. §119 of Korean Patent Application No. 10-2012-0044222, filed on Apr. 27, 2012, the entire contents of which are hereby incorporated by reference.

### BACKGROUND

The present inventive concept herein relates to medication service terminals and methods of monitoring the same, and more particularly, to a method of monitoring medication states of a plurality of users.

As awareness about ubiquitous environment extends with the development of various sensor technologies, technological attempts for improvement of residential environment are actively being made. In particular, requirements for health care increase while the atmosphere of the age pursuing qualitative improvement of the life is formed.

A chronic disease patient who needs continuous medication for health care should regularly take medicine following the fixed pattern. However, actually the case that patient forgets a medication time or patient forgets the fact itself that he took medicine frequently occurs. This may cause fatal consequences on health. Thus, a technology for taking medicine support such as notification for medication support is required.

An example of conventional commercial off-the-shelf is a medicine case receiving medicine on a daily basis and carrying the received medicine. However, since there is not a notification function in a medicine case, a patient cannot know when he should take medicine. There is a medicine case alarming medication at the appointed time by adding a time setting function to the medicine case. However, even in this case, patient cannot know whether or not he took medicine.

### SUMMARY

Embodiments of the inventive concept provide a medication service terminal The medication service terminal may include a situation judgment module judging a medication situation with reference to a medication providing schedule and a terminal state that are provided from a server; and an output module determining a medication service corresponding to the medication situation and providing the determined medication service in the form that a user can sense. A communication with the server is performed only when the situation judgment module receives a medicine providing schedule from the server.

Embodiments of the inventive concept also provide a method of monitoring medication. The method may include a step that a medication service terminal senses a medicine code and a terminal state; a step that a server stores a medication schedule; and a step that if the medicine code does not correspond to the terminal state, the server provides the medication schedule corresponding to the medicine code to the medication service terminal

### BRIEF DESCRIPTION OF THE FIGURES

Preferred embodiments of the inventive concept will be described below in more detail with reference to the accompanying drawings. The embodiments of the inventive concept may, however, be embodied in different forms and should not be constructed as limited to the embodiments set forth herein. Rather, these embodiments are provided so that this disclosure will be thorough and complete, and will fully convey the scope of the inventive concept to those skilled in the art. Like numbers refer to like elements throughout.

FIG. 1 is a block diagram illustrating a terminal-dominated medication monitoring system.

FIG. 2 is a block diagram illustrating a server-dominated medication monitoring system.

FIG. 3 is a block diagram illustrating a hybrid type medication monitoring system in accordance with the inventive concept.

FIG. 4 is a flow chart for explaining an operation of hybrid type medication monitoring system in accordance with the inventive concept.

### DETAILED DESCRIPTION OF THE EMBODIMENTS

Embodiments of inventive concepts will be described more fully hereinafter with reference to the accompanying drawings, in which embodiments of the invention are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

The medication monitoring system in accordance with the inventive concept consists of a service terminal and a server. The service terminal provides a situational medication service to a user. The medication service includes notification of medication, warning, medicine excretion, medication guidance, etc.

The server manages a medication schedule of user and a medication result of user. In a general case, the server generates and manages a medication schedule and a medication result is expressed in each medication schedule. Different medication monitoring systems can be made depending on how it is checked whether medication is performed or not or where situation deduction is performed. That is, the medication monitoring system may be divided into a terminal dominated medication monitoring system, a server dominated medication monitoring system and a hybrid type medication monitoring system.

The medication monitoring system should satisfy the following requirements. Functions of service terminals should be maximally performed without the burden of server while the number of users increases. The frequency of communication between the server and the service terminal should be minimized The medication monitoring system in accordance with the inventive concept can economically provide a medication service to a massive user.

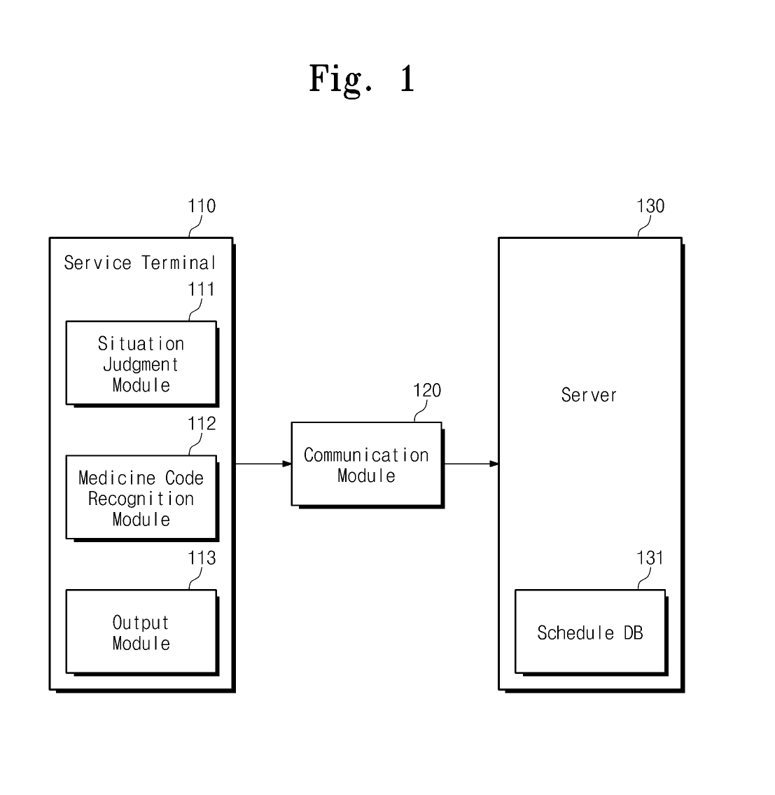

FIG. 1 is a block diagram illustrating a terminal-dominated medication monitoring system. Referring to FIG. 1, the terminal-dominated medication monitoring system includes a service terminal 110, a communication module 120 and a server 130. A communication between the service terminal 110 and the service 130 is performed by the communication module 120.

The service terminal 110 includes a situation judgment module 111, a medicine code recognition module 112 and an output module 113. A medication schedule is input into the service terminal 110. The medication schedule is stored in a memory of the service terminal 110 and may be transmitted to the server 130 through the communication module 120. The medication schedule transmitted to the server 130 may be stored in a schedule DB 131.

The medicine code recognition module 112 recognizes a code of medicine prepared in the service terminal 110. That is, the medicine code recognition module 112 identifies a code expressed on the medicine to search a medication schedule corresponding to the code. When the medicine code is not recognized, the medicine code recognition module 112 judges that prepared medicine does not exist in the service terminal 110.

The situation judgment module 111 judges the medication situation of user with reference to a current time, a terminal state, schedule data, etc. If it is time to take medicine now and the service terminal 110 prepares the medicine, the situation judgment module 111 determines that it is a situation to notify the medication.

If a user pushes a medicine excretion button in a medication notification situation, the situation judgment module 111 determines that it is a medication situation. If a user pushes a medicine excretion button even though it is not a medication situation, the situation judgment module 111 regards it as a prior medicine excretion for going out to determine that it is a going out situation.

The output module 113 provides a service corresponding to a deducted situation. The service includes a sound, a voice, a text, a LED expression, etc. which is suitable for a corresponding situation.

A service provided by the service terminal 110 and a reaction of user to the service may be transmitted to the server 130. That is, a situation such as medication notification completion, medication completion, going out completion, etc. may be transmitted to the server 130 through the communication module 120. The situation is interpreted by the server 130 to be stored in the schedule DB 131.

In the terminal-dominated medication monitoring system, a user should personally input a medication schedule into the service terminal 110 and a structure of the service terminal 110 is complicated.

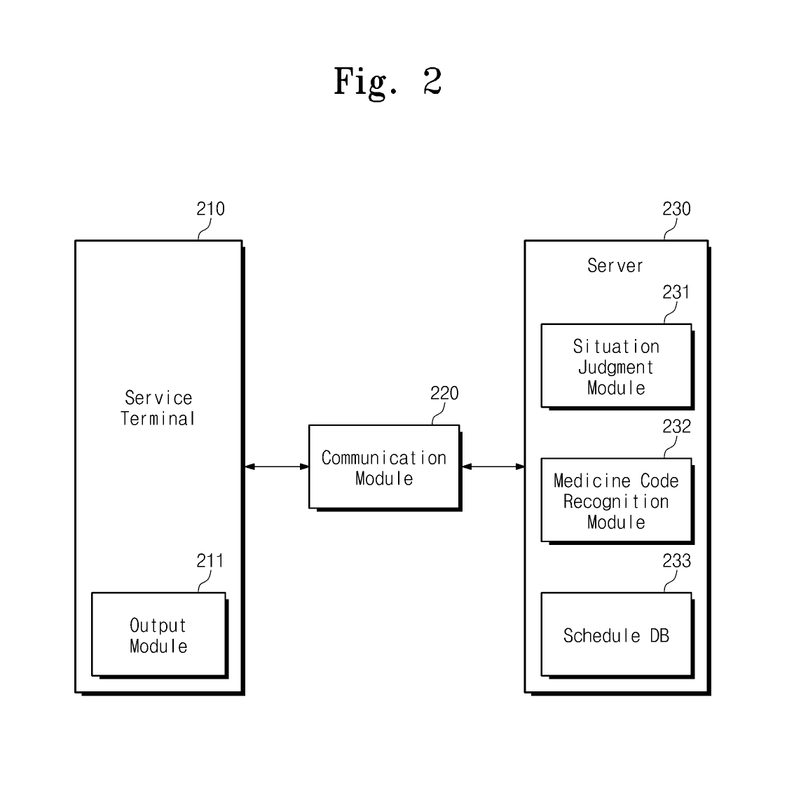

FIG. 2 is a block diagram illustrating a server-dominated medication monitoring system. Referring to FIG. 2, the server-dominated medication monitoring system includes a service terminal 210, a communication module 220 and a server 230. A communication between the service terminal 210 and the server 230 is performed by the communication module 220.

Unlike the terminal-dominated medication monitoring system, in the server-dominated medication monitoring system, a medication schedule is directly input into the server 230. The medication schedule is stored in a schedule DB 233 of the server 230.

The service terminal 210 asks the server 230 for a communication connection. A thread is formed between the service terminal 210 and the server 230. The thread is maintained until the service is over. Thus, in the server-dominated medication monitoring system, the frequency of communication between the service terminal 210 and the server 230 is very high.

A situation judgment module 231, a medicine code recognition module 232 and a schedule DB 233 are same with those of the terminal-dominated medication monitoring system. A difference is that operations of the situation judgment module 231, the medicine code recognition module 232 and the schedule DB 233 are performed in the server 230.

In the server-dominated medication monitoring system, since the service terminal 210 performs only a service provided from the server 230, a structure of the service terminal 210 is very simple. However, since the server 230 should generate a thread to all the users and should recognize a situation, a structure of the server 230 becomes very complicated. Since the service terminal 210 should continuously monitor data from the server 230, the frequency of communication between the service terminal 210 and the server 230 is very high.

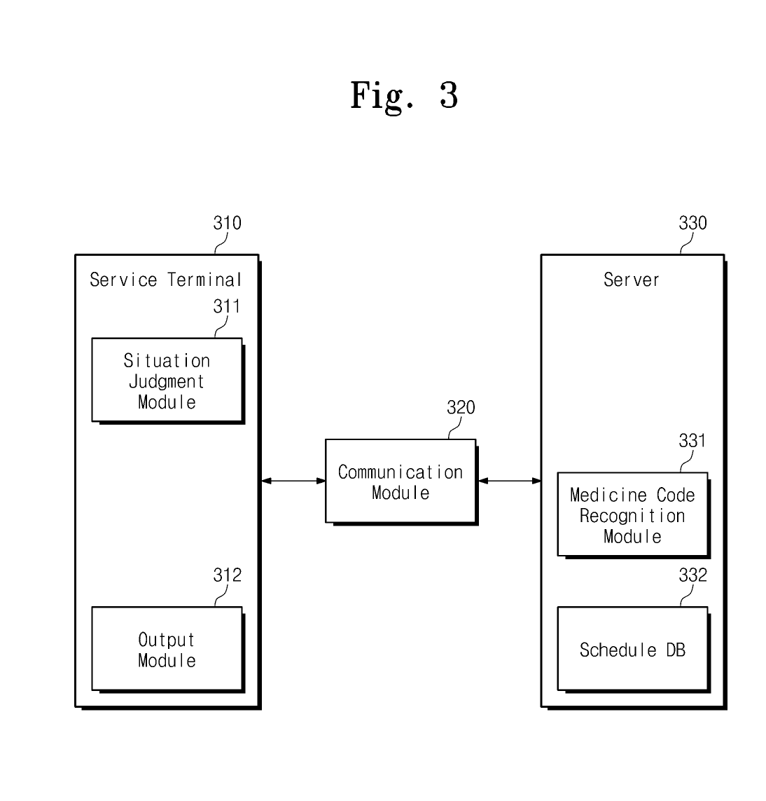

FIG. 3 is a block diagram illustrating a hybrid type medication monitoring system in accordance with the inventive concept. Referring to FIG. 3, the hybrid type medication monitoring system includes a service terminal 310, a communication module 320 and a server 330. A communication between the service terminal 310 and the server 330 is performed by the communication module 320.

The service terminal 310 includes a situation judgment module 311 and an output module 312. The server 330 includes a medicine code recognition module 331 and a schedule DB 332. A communication connection between the service terminal 310 and the server 330 is formed only when necessary.

Unlike the server-dominated medication monitoring system, in the hybrid type medication monitoring system, it is not necessary that one thread is closely connected to one service terminal 310. That is, in the hybrid type medication monitoring system, it is only needed to assign one thread not being used at the moment is to the service terminal 310 only when necessary.

This method can reduce a burden of the server 330 with respect to a massive user while maintaining an advantage of the terminal-dominated medication monitoring system.

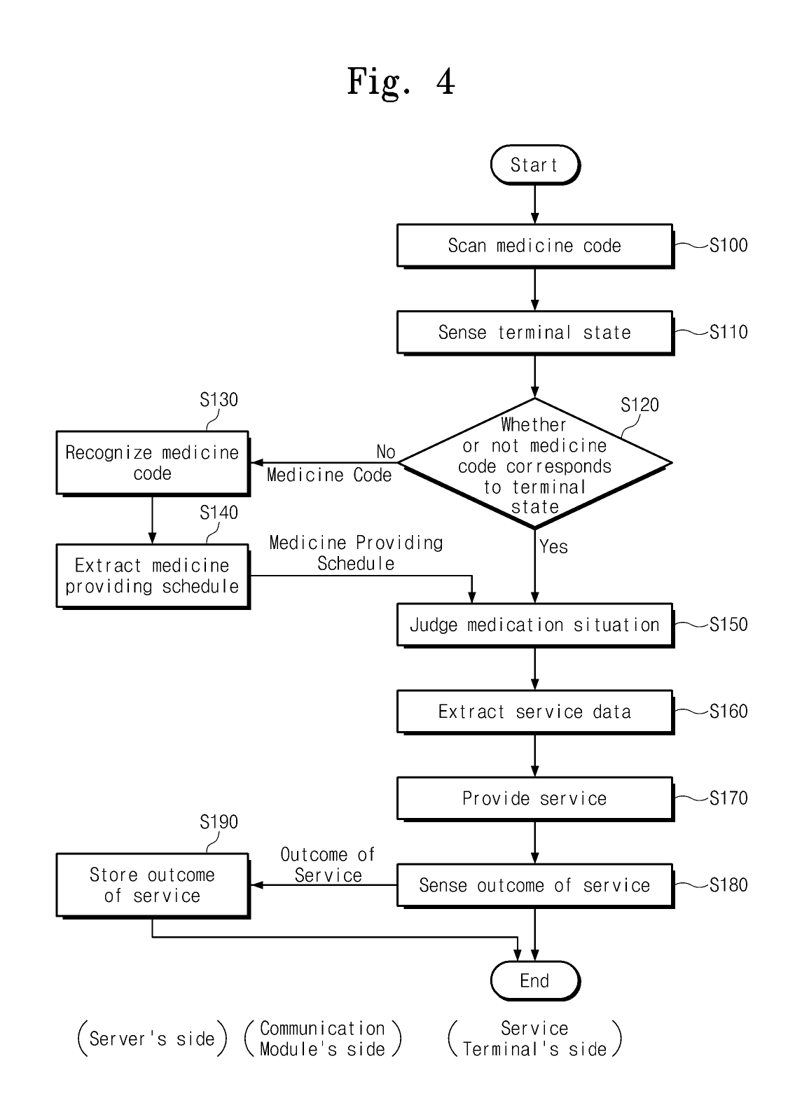

FIG. 4 is a flow chart for explaining an operation of hybrid type medication monitoring system in accordance with the inventive concept.

The service terminal 310 detects a medicine code stored inside the service terminal 310 (S100). The service terminal 310 can detect a medicine code using the various methods. A barcode reader inside the service terminal 310 scans a barcode attached to a medicine, so that the service terminal 310 can detect a medicine code. A RFID reader read an RFID tag attached to a medicine, so that the service terminal 310 can detect a medicine code.

The service terminal 310 monitors a state of the service terminal 310 (S110). The service terminal 310 can detect whether a medicine excretion button included in the service terminal 310 is pushed or not.

With reference to a prior medicine state and a terminal state, the service terminal 310 judges whether a prior medicine code corresponds to a terminal state or not (S120). If a prior medicine code does not correspond to a terminal state, the service terminal 310 provides a medicine code to the server 330.

That a prior medicine code does not correspond to a terminal state means that a medicine providing schedule which the service terminal 310 holds now is not valid. Since the medicine providing schedule which the service terminal 310 holds now is not valid, it is required that the service terminal 310 receives a valid medicine providing schedule from the server 330.

That a prior medicine code corresponds to a terminal state means that a medicine providing schedule which the service terminal 310 holds now is valid.

Since the medicine providing schedule which the service terminal 310 holds now is valid, it is not necessary that the service terminal 310 receives a separate medicine providing schedule from the server 330.

That is, since in the inventive concept, the service terminal 310 detects a medicine code and asks the server 330 for a valid medicine providing schedule only when a medicine providing schedule is not a valid, a communication between the service terminal 310 and the server 330 may become minimized.

Referring back to FIG. 4, the server 330 recognizes a medicine code according to a medicine code provided from the service terminal 310 (S130). The server 330 extracts a medicine providing schedule corresponding to the recognized medicine code from the schedule DB 332 (S140). The medicine providing schedule may include a medicine code, a user's name, a medicine time, a medicine guidance, etc.

The extracted medicine providing schedule is transmitted to the service terminal 310. The service terminal 310 judges a current medicine situation with reference to a terminal state and a medicine providing schedule (S150). The situation judgment module 311 inside the service terminal 310 deduces a current medication situation through a terminal state and schedule data about medicine code. That is, the situation judgment module 311 deduces a medication notification situation, a medication situation, a going out situation, an error situation, etc.

The service terminal 310 extracts service data according to a medication situation (S160). The service terminal 310 provides a medication service to a user according to the extracted service data (S170). When a user does not take a medicine although a medication time passes, the service terminal 310 can express a sound or image notifying a medication to a user.

A sensor inside the service terminal 310 senses the outcome of service provided to a user (S180). The service terminal 310 can sense that a user takes out a medicine by sensing that a medicine entrance is open. The sensed outcome of service is transmitted to the server 330 and is stored in DB inside the server 330 (S190). The outcome of service may include a medication time, a notification time, a going out time, an error time, etc.

In the inventive concept, one service is processed during one communication connection. Thus, while a service is not processed, an unnecessary communication connection is not formed. Since the frequency of service performed in the service terminal 310 is low, it is more economical to form a communication connection only when necessary than to maintain a communication connection at all times. That is, since a communication between the service terminal 310 and the server 330 is performed only when necessary, a burden of the server 330 is reduced and consequently, the system can stably operate.

According to some embodiments of the inventive concept, a medication monitoring system can be effectively provided to a massive user.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the present invention. Accordingly, all such modifications are intended to be included within the scope of the present invention as defined in the claims. The present invention is defined by the following claims, with equivalents of the claims to be included therein

What is claimed is:

1. A medication service terminal comprising:
a situation judgment module judging a medication situation with reference to a medication providing schedule and a terminal state that are provided from a server; and
an output module determining a medication service corresponding to the medication situation and providing the determined medication service in the form that a user can sense,
wherein a communication with the server is performed only when the situation judgment module receives a medicine providing schedule from the server.

2. The medication service terminal of claim 1, wherein the stored medicine code is detected and if the detected medicine code does not correspond to the terminal state, a communication connection with the server is formed and the medicine code is provided to the server.

3. The medication service terminal of claim 2, wherein the server extracts the medicine providing schedule corresponding to the provided medicine code.

4. The medication service terminal of claim 3, wherein after a communication connection with the server is formed, the medicine providing schedule extracted from the server is provided.

5. The medication service terminal of claim 1, wherein the outcome of the medication service corresponding to the provided medication service is detected and the detected outcome of the medication service is provided to the server.

6. The medication service terminal of claim 1, wherein the medicine providing schedule is stored in a schedule DB inside the server.

7. A method of monitoring medication comprising:
a step that a medication service terminal senses a medicine code and a terminal state;
a step that a server stores a medication schedule; and
a step that if the medicine code does not correspond to the terminal state, the server provides the medication schedule corresponding to the medicine code to the medication service terminal.

8. The method of claim 7, if the medicine code does not correspond to the terminal state, further comprising a step that the medication service terminal provides the medicine code to the server.

9. The method of claim 7, further comprising a step that the medication service terminal determines a corresponding medication service with reference to the provided medication schedule and the terminal state and the determined medication service is provided in the form that a user can sense.

10. The method of claim 9, further comprising a step that the medication service terminal senses the outcome of the medication service and provides the sensed outcome of the medication service to the server.
